(19) United States
(12) Patent Application Publication
(10) Pub. No.: US 2026/0168520 A1
(43) Pub. Date: Jun. 18, 2026

(54) System and Method for Controlling a Hydraulic Supply System on a Mobile Machine

(71) Applicant: AGCO International GmbH, Neuhausen (CH)

(72) Inventors: Gabriel Reitemann, Marktoberdorf (DE); Benjamin Frommelt, Marktoberdorf (DE)

(21) Appl. No.: 18/708,111

(22) PCT Filed: Nov. 15, 2022
(86) PCT No.: PCT/IB2022/060973

§ 371 Date: May 7, 2024

(30) Foreign Application Priority Data
Dec. 3, 2021 (GB) 2117534.4

(51) Int. Cl. F15B 11/16; E02F 9/22; F15B 13/04

(52) U.S. Cl. CPC F15B 11/163; E02F 9/2235; E02F 9/2242; E02F 9/2285; E02F 9/2292; E02F 9/2296; F15B 13/0417; F15B 2211/20546; F15B 2211/6054

(57) ABSTRACT

A control system for hydraulic supply system on a tractor includes an electronic load sensing (E-LS) system. The control system is configured to limit the pump supply pressure PSP so that the load sensing pressure LSP reported by at least one valve (CMV, RMV, IMV) does not exceed a pre-defined upper limit of LSP assigned to that valve. Since the LSP reported by a valve is indicative of the pressure at a working port of the valve, monitoring the LSP and limiting the PSP in dependence on LSP can be used to ensure the pressure at the working port does not exceed a permitted value. In an embodiment, the system monitors pressure signals indicative of LSP from a number of valves whilst increasing the PSP to meet a hydraulic demand and stops increasing the PSP if the LSP of any of the valves exceeds a respective pre-defined upper limit.

### CROSS-REFERENCE TO RELATED APPLICATIONS

This application is a national phase entry under 35 U.S.C. § 371 of International Patent Application PCT/IB2022/060973, filed Nov. 15, 2022, designating the United States of America and published in English as International Patent Publication WO 2023/100005 A1 on Jun. 8, 2023, which claims the benefit of the filing date of U.K. Patent Application 2117534.4 “System and Method for Controlling a Hydraulic Supply System on a Mobile Machine,” filed Dec. 3, 2021, the entire disclosure of which is incorporated herein by reference.

### FIELD

The disclosure relates to a control system for controlling a pressurized fluid supply system on a mobile machine. The control system is particularly applicable for use with a pressurized fluid supply system on a mobile agricultural machine, such as a tractor, which is capable of supplying pressurized fluid to consumers on the machine and to consumers on an agricultural implement attached to the machine. The disclosure also relates to a mobile machine, or to a combination of a mobile machine and attached implement, having such a control system, and to a method of controlling a pressurized fluid supply system on a mobile machine or on a mobile machine and attached implement combination.

### BACKGROUND

Pressurized fluid (hydraulic) supply systems are widely used to drive consumers on agricultural or construction mobile machines, e.g. a tractor or a self-propelled harvester, or on implements attached thereto. Such mobile machines will be referred to hereinafter simply as machines and are sometimes referred to as vehicles. These hydraulic systems are mostly provided with a pump supply, consumers, control means (respectively control valves) and a tank to provide a fluid reservoir. The term “consumer” is used in the further description to encompass hydraulic drives such as rotary motors or linear rams but also for the respective control valves assigned to these drives. The term “control” in relation to supply systems hereby includes any adjustment of the supply system regarding direction, supply time or pressure of the fluid flow or the delivery of the pump used to supply the system. The term “pump supply” includes the pump and all valve means which are needed to adjust the fluid flow and/or fluid pressure supplied by the pump to a pump supply line. The pressure of the fluid provided by the pump supply being referred to herein as the pump supply pressure PSP.

In a hydrostatic hydraulic system, a pressure differential is needed to provide hydrostatic work (an output). This pressure differential between the pump supply (source) and consumer results in a fluid flow which is sufficient to undertake work, such as to lift a tractor three-point hitch or a operate a rotary drive on an implement or in a hydrostatic drive for example. Furthermore, a stand-by or static pressure differential ΔPₛₜ is also needed when the system is otherwise in idle mode to keep control valves (assigned to consumers) responsive so that the spool of the valve can be moved on demand.

Hydraulic losses are present whenever oil circulates within a hydraulic system even when no consumer is operated. To mitigate this problem, it is known to provide means to forward a demand of a consumer to the pump supply. These systems are generally called load sensing systems (the term load sensing is abbreviated to LS). In such systems, a load induced pressure demand of the consumers, hereafter referred to as a “load sensing pressure” LSP, is hydraulically fed back to the pump supply via pipes or hoses so that pump supply oil flow/pressure can be adjusted according to the needs of the consumers. This load sensing pressure LSP feedback signal is typically generated by the control valve assigned to a consumer and the highest load sensing pressure LSP of all the consumers supplied by the pump is used to adjust the pump supply.

In general, there are two different types of hydraulic supply systems with LS demand feedback available on the market-closed-center load sensing systems (CC-LS systems) and open-center load sensing systems (OC-LS systems).

CC-LS systems are equipped with variable displacement pumps whereby the demand of the consumers is hydraulically fed back to the pump supply including an adjustment means for the pump so that the displacement of the pump is adjusted according to the needs of the consumers.

To ensure that a stand-by pressure differential ΔPₛₜ is maintained in the supply to support fast system response, the pump is kept on low displacement to compensate for losses/leakage resulting in a stand-by pressure even if there is no demand by consumers. As a result of the reduction of the hydraulic fluid circulation, losses and power input required by the pump are reduced.

FIG. 1 illustrates part of a simplified known CC-LS hydraulic circuit. A pump supply 10 includes a variable displacement pump 12 which draws fluid from a tank 14 and forwards pressurized fluid to consumers (not shown) via a pump supply line P. Fluid is returned to the tank from the consumers via a return or tank line T. The pump 12 can be any suitable variable displacement pump and could, for example, be a swash plate axial piston pump in which the displacement of the pump is changed by pivoting the swash plate by means of a pump actuator 16 to vary the piston stoke. In the arrangement illustrated, actuator 16 is biased by a spring to pivot the swash plate in a direction to increase pump displacement and hence the output of the pump. Pressurized fluid introduced into a chamber 20 of the actuator opposes the force of the spring and if the force of the fluid is greater than that of the spring the swash plate is pivoted to reduce the delivery of the pump.

Operation of the actuator 16 is controlled by a flow control valve 22 and a pressure limiting valve 24, which together with the actuator 16 form a pump controller and form part of the pump supply 10. Each of the valves is biased by a respective spring 26, 28 to the position shown in which the actuator chamber 20 is connected to the tank 14. Each of the valves has a pump pressure port 30, 32 connected to the pressure line P of pump so that the fluid pressure acting on the valve spool through the pump pressure port 30, 32 opposes the force of the respective spring 26, 28. The flow control valve 22 also has a LS pressure port 34 to which a load sensing pressure signal line LS is connected. The highest consumer load sensing pressure LSP of the various consumers in the hydraulic LS system is fed into the LS pressure signal line so that the load sensing pressure LSP is added to the force of the spring to move the valve spool towards the position shown. The spring 26 in the flow control valve sets the stand-by pressure differential ΔPₛₜ which is typically in the region of 10 to 30 bar for tractor applications. The spring force may be adjustable to enable the stand-by pressure differential ΔPₛₜ to be adjusted. The spring 28 of the pressure limiting valve sets the maximum operating pressure of the system, which could be in the region 250 bar in the present example. Again, the spring force may be adjustable to enable the maximum operating pressure to be adjusted.

In normal operation when the system is at idle with no demand from the consumers, the pump supply pressure PSP acting through the pump pressure port 30 of the flow control valve 22 moves the spool against the force of the spring 26 to introduce pressurized fluid in to the chamber 20 of the actuator. This causes the actuator to pivot the swash plate and reduce the output of the pump until the pump supply pressure PSP balances the force of the spring 26 so that the output of the pump is held at the stand-by pressure ΔPₛₜ.

When a load sensing pressure signal LSP (or an increasing load sensing pressure signal) is reported to the LS pressure port 34 via the LS sensing line, this is added to the force of the spring 26 moving the valve spool so that the fluid pressure in the chamber 20 of the actuator is reduced. In response, the actuator 16 moves the swash plate to increase the output of the pump until the pump supply pressure PSP balances the force of the spring 26 and the load sensing pressure signal LSP. The pump therefore delivers a pump supply pressure PSP that is higher than the load sensing pressure LSP by the stand-by pressure differential ΔPₛₜ.

The pressure limiting valve 24 is usually held in the position shown by the spring 28 so that fluid passes into and out of the actuator chamber 20 under the control of the flow control valve 22. However, should the pump supply pressure PSP exceed the maximum permitted system pressure, as defined by the spring 28, the spool of the pressure limiting valve 24 is moved against the spring force to admit pressurized fluid into the chamber 20 of the actuator. This reduces the output of the pump until the pump supply pressure PSP it is brought back below the maximum permitted system pressure.

Generally, CC-LS systems are more expensive and complex than OC-LS systems but they have the advantage that the pump is only delivering above the stand-by pressure ΔPₛₜ on demand. This has a positive effect on the overall system efficiency. These systems are mainly used in high performance and high specification tractors (e.g. >100 kW) used to supply complex and powerful implements.

In contrast to CC-LS systems, OC-LS systems are provided with a fixed displacement pump. FIG. 2 illustrates part of a simplified OC-LS hydraulic circuit. A constant displacement pump 12′ draws hydraulic fluid from a tank 14 and delivers it to various consumers (not shown) via a pump supply or pressure line P. Fluid is returned to the tank 14 from the consumers via a return or tank line T. A proportional pressure compensator valve 40 forms part of the pump supply and is operative to selectively connect the pump supply line P to the tank 14. The spool of the valve 40 is biased by a spring 44 towards a closed position, as shown, in which pump supply line P is not connected to the tank. This spring sets a static or stand-by pressure differential ΔPₛₜ and the spring force may be adjustable to enable the stand-by pressure differential ΔPₛₜ to be adjusted. The pump supply pressure PSP is applied to the opposite end of the spool via a pressure port 46 to oppose the force of the spring. The valve also has an LS pressure port 48 through which a consumer load sensing pressure signal LSP is applied to the valve spool to act in addition to the spring force.

In an idle mode in which there is no consumer demand, the pump supply pressure PSP opposes the spring force to open the valve and connect the pump supply line P to the tank. The pump supply pressure PSP in the pump supply line falls until it balances the spring force and is then held at the stand-by pressure differential ΔPₛₜ. If a consumer load sensing pressure signal LSP is forwarded to the valve 40 via the LS pressure port 48, this adds to the spring force tending to close the valve so that the pump supply pressure PSP increases until it balances the combination of the spring force and the load sensing pressure LSP. The pump supply pressure PSP is thereby held a level which is higher than the load sensing pressure LSP by the stand-by pressure differential ΔPₛₜ defined by the spring 44.

A further trend can be seen related to the supply and control means used on implements attached to an agricultural machine, such as a tractor. Due to increasing automation in agricultural work, implements are provided with more and more control functions which require complex control strategies. While in the past implements were equipped with only a few controllable drives (e.g. hydraulic cylinders or motors) which were controlled by valves on the tractor, today implements are provided with numerous controllable drives which cannot be controlled by the valves installed on the tractor. To address this, tractors are often equipped with power beyond systems (which may also be referred to in the art as high-pressure carry over). As the name suggests, these systems supply an uncontrolled (at the tractor) fluid flow from the pump supply to the implement via a respective interface, such as quick couplers. The implement itself is then equipped with control means in form of valves to adjust the parameters of the fluid supply. Similar to internal consumers on the tractor, these power beyond systems also include a LS function so that the load sensing pressure of consumers on the implement can be fed back to the pump supply on the tractor via a hydraulic LS line.

A typical power beyond interface 50 is illustrated in FIG. 1 and includes quick release hydraulic couplings 50a, 50b, 50c for releasably connecting a pump supply line P, a return or tank line T, and an LS signal line on the tractor to equivalent hydraulic lines Pi, Ti, LSi on the implement. As illustrated, the LS line (LS_{pb}) from the power beyond interface which reports a LS signal from the consumers on the implement and an LS line (LSₜ) which reports a LS signal from the consumers on the tractor are connected to the LS pressure port 34 on the flow control valve 22 though a shuttle valve 52 or another functionally similar arrangement. This ensures that the highest LS load sensing pressure signal from the implement or the tractor is used to control the output of the pump. If there are a number of consumers on the implement, shuttle valves are used to ensure the highest LS load sensing pressure signal LSP of the implement consumers is fed through to the power beyond LS connection 50c. Similarly, if there are a number of consumers on the tractor, shuttle valves or other functionally similar arrangements are used to feed the highest LS load sensing pressure signal LSP of the tractor consumers to the LSₜ line and hence to the shuttle valve 52.

A major advantage of the power beyond system is that the costs involved with fluid supply control are moved from the tractor to the implement so that a wider range of applications can be handled by tractors with reduced hydraulic control capability. These power beyond systems have mainly been the reserve of tractors with higher performance (>100 kW) and CC-LS systems. However, a demand has been recognized for smaller tractors with OC-LS systems to provide power beyond, for example vineyard tractors with about 70 kW have to provide a supply to complex implements such as fruit harvesters equipped with many hydraulic drives to be controlled.

A drawback with purely hydraulic LS arrangements is that the hydraulic load sensing pressure signal LSP has to be forwarded to the pump supply by hydraulic lines. If the load sensing pressure signal LSP comes from a consumer on an implement, a coupling is required to releasably connect the implement hydraulic LS signal line with a hydraulic LS signal line on the tractor. Furthermore, the various hydraulic LS signal lines from different consumers must be connected via shuttle valves to ensure that the highest consumer load sensing pressure LSP is forwarded to the pump supply. This all involves considerable additional expense and takes up valuable installation space. To overcome these drawbacks, electrohydraulic load sensing (E-LS) arrangements have been developed.

U.S. Patent Application Publication 2007/0151238 A1, “Hydrostatic Drive System,” published Jul. 5, 2007, discloses a hydrostatic drive system in which a variable displacement pump controller is actuated electronically by an electronic control device. A pressure sensor is used to detect a hydraulic consumer load sensing pressure LSP and provides an input to the electronic control system. The electronic control system generates an electronic control signal for actuating the displacement pump controller via a LS control valve to set the pump supply pressure PSP so that it is higher than the sensed load sensing pressure LSP by a set amount ΔPₛₜ. The system avoids the need for lengthy hydraulic LS load sensing pressure signal lines.

German Patent 102014103932 B3, “Control Device for a Hydraulic Working Machine, Hydraulic System and Method for Controlling a Hydraulic System,” granted Jul. 23, 2015, discloses an E-LS system for an implement towed by a tractor. The towed implement has an electronic control device which determines the difference between the pump supply pressure PSP and the highest load sensing pressure LSP of the consumers on the towed implement. An electronic signal indicative of the pressure difference is forwarded to a hydraulic control module coupled to a LS connection of a variable displacement pump on the tractor. The hydraulic control module converts the electronic signal to a hydraulic control signal for controlling the pump displacement.

U.S. Patent Application Publication 2019/0345694 A1, “Hydraulic Control Arrangement for an Arrangement of Mobile Machines, and Arrangement of Mobile Machines,” published Nov. 14, 2019, discloses a further E-LS system for a tractor and towed implement which does not necessarily require an electronic controller on the implement. In the arrangement disclosed, a pressure sensor is provided on the tractor to detect a hydraulic LS load sensing pressure signal LSP provided by the implement via a power beyond LS coupling. The pressure sensor forwards an electronic load sensing pressure signal ELSPS representative of the hydraulic load sensing pressure LSP to an electronic control unit on the tractor which controls a transducer (e.g. a solenoid actuated pressure limiting valve) to provide a hydraulic pump supply control signal HPSCS having a pressure Pₛₑₜ for forwarding to a variable displacement pump controller. A further pressure sensor may be provided to forward an electronic load sensing pressure signal ELSPS representative of the highest load sensing pressure LSP of a number of consumers on the tractor. In this case, the electronic control unit selects the highest of the electronic load sensing pressure signals to use as a basis to control the transducer. The hydraulic pump supply control signal HPSCS output from the transducer may be connected with the pump controller via a shuttle valve, with a hydraulic load sensing pressure signal LSP from a steering system providing a further input to the shuttle valve. In this case, the highest pressure of the hydraulic pump supply control signal HPSCS from the transducer or the load sensing pressure LSP from the steering system is forwarded to the pump controller. This illustrates how E-LS and traditional hydraulic LS can be combined.

Arrangements for adjusting the pump supply pressure PSP in an E-LS system can be similar to those illustrated in either of FIGS. 1 and 2, except that a hydraulic pump supply control signal HPSCS for application to the LS pressure port 34, 48 of a flow control valve 22 or pressure compensator valve 40 is produced using a suitable transducer in dependence on an electronic pump supply control signal EPSCS from the controller. The transducer may be a solenoid-controlled pressure limiting valve, for example. The solenoid valve is actuated by the controller as a function of the hydraulic load sensing pressure demand LSP detected by a pressure sensor.

FIG. 3 illustrates how a pump supply 10 including a variable displacement pump 12 similar to that described above in relation to FIG. 1 can be adapted to incorporate a solenoid-controlled pressure limiting valve for use with an E-LS system. The pump supply 10 includes a flow control valve 22′ to control the flow of fluid between the pump supply line P, the chamber 20 of the pump control actuator 16 and the tank 14. As in the hydraulic LS system of FIG. 1, a spring 26 sets the stand-by or static pressure differential and is opposed by the pressure in the pump supply line P connected to the pressure port 30 of the flow control valve 22′. However, for use in an E-LS system, the fluid pressure Pₛₑₜ supplied to the LS pressure port 34 is set by a solenoid-controlled pressure limiting valve 54. When no current is provided to the solenoid 56 of the pressure limiting valve 54, the LS pressure port 34 is fully connected to the tank 14 and the pump supply pressure PSP at port 30 is opposed only by the force of the spring 26 in the flow control valve 22′ so that the pump output is maintained at the stand-by pressure ΔPₛₜ. When a consumer load sensing pressure LSP is detected by a pressure sensor and forwarded to a controller, the controller generates an electronic pump supply control signal EPSCS which is forward to the solenoid of the pressure limiting valve 54. The electronic pump supply control signal EPSCS actuates the pressure limiting valve 54 so that a hydraulic pump supply control signal HPSCS at a pressure Pₛₑₜ is applied at the LS port 34 of the flow control valve 22′ in addition to the spring force. This causes the pump displacement to be increased until the pump supply pressure PSP balances the combination of the spring force and the pressure Pₛₑt of the hydraulic supply control signal HPSCS.

As illustrated in U.S. Patent Application Publication 2019/0345694 A1, the hydraulic pump supply control signal HPSCS generated by the pressure limiting valve 54 may be forwarded to the LS port 34 via a shuttle valve with conventionally generated hydraulic load sensing pressure signal LSP provided as second input to the shuttle valve. This arrangement enables an E-LS system to be integrated with a conventional, hydro-mechanical hydraulic LS system.

For use with a fixed displacement pump arrangement such as that illustrated in FIG. 2, a solenoid actuated pressure limiting valve 54 can be used to generate a hydraulic pump supply control signal HPSCS for application to the LS pressure port 48 of the pressure compensator valve 40.

Other electronically controlled transducer arrangements can be used to convert an electronic pump supply control signal EPSCS into a hydraulic pump supply control signal HPSCS.

Though the known E-LS systems and methods work well and alleviate some of the problems of a purely hydraulic LS system, they have their own drawbacks. One issue the applicant has found is that E-LS increases the overall reaction time to adjust the pump supply pressure PSP in response to an increase in consumer load sensing pressure LSP. This can be explained by the fact that in a hydraulic LS system, the load sensing pressure signal LSP is forward by a generally static fluid column in the LS lines which immediately forwards a load sensing pressure demand. In electrohydraulic E-LS systems, the pressure sensors must communicate with the controller and the controller must communicate with the solenoid pressure limiting valve or other actuator for adjusting the pump supply pressure. This communication typically takes place over CAN or ETHERNET-BUS Networks. As a consequence, the electronic LS signal transfer depends on cycle times and these depend on the performance levels of the components. With the numerous electronic control systems used in agricultural machines today, the overall response time may be considerably higher compared to purely hydraulic LS systems.

There is a need then for alternative methods of controlling a hydraulic supply system which overcome, or at least mitigate, some or all of the drawbacks of the known methods and a need to provide hydraulic supply systems configured to carry out such alternative methods.

There is also an ongoing desire to improve the way hydraulic systems are controlled to optimize functioning of the system depending on operational and/or economic requirements. For example, in some circumstances it may be desirable to compensate losses in the hydraulic system by adjusting the pump to a higher delivery or pressure level. It is desirable, therefore, to provide methods of operating a hydraulic supply system using E-LS which provides for greater flexibility in pump delivery setting depending on consumer load sensing pressure demand LSP and hydraulic systems configured to carry out such methods.

### BRIEF SUMMARY

Aspects of the disclosure relate to a control system for controlling a hydraulic supply system of a mobile machine and/or of a mobile machine and attached implement combination, to mobile machine/mobile machine/attached implement combination, and to a method for controlling a hydraulic supply system of a mobile machine and/or of a mobile machine and attached implement combination.

In some embodiments, there is provided a control system for controlling a hydraulic supply system on a mobile machine. The hydraulic supply system includes a pump supply for supplying a pressurized fluid to a plurality of consumers on the mobile machine and/or an implement attached to the mobile machine. The control system includes an electronic load sensing (E-LS) system for controlling a pump supply pressure PSP of the pump supply in dependence on a hydraulic load demand of at least some of the consumers, the E-LS system including one or more controllers and a plurality of pressure sensors. Each pressure sensor is associated with at least one valve of the hydraulic supply system and is configured to forward to the one or more controllers a pressure signal indicative of a sensed load sensing pressure LSP of the at least one associated valve. The control system is configured to limit the pump supply pressure PSP so that a load sensing pressure LSP reported by at least one valve does not exceed a pre-defined upper limit of load sensing pressure LSP assigned to that valve.

In some embodiments, there is provided a control system for controlling a hydraulic supply system on a mobile machine, wherein the hydraulic supply system includes a pump supply for supplying a pressurized fluid to a plurality of consumers on the mobile machine and/or an implement attached to the mobile machine. The control system includes an electronic load sensing (E-LS) system for controlling a pump supply pressure PSP of the pump supply in dependence on a hydraulic load demand of at least some of the consumers. The E-LS system includes one or more controllers and a plurality of pressure sensors. Each pressure sensor is associated with at least one valve of the hydraulic supply system and configured to forward to the one or more controllers a pressure signal indicative of a sensed load sensing pressure LSP of the at least one associated valve. The one or more controllers are configured to monitor pressure signals from the pressure sensors and to increase the pump supply pressure PSP in response to an increase in the load sensing pressure LSP of one of the valves associated with a pressure sensor above the current pump supply pressure PSP in an effort to raise the pump supply pressure PSP to match the load sensing pressure LSP. The one or more controllers are configured when operating in at least one mode of operation to stop increasing the pump supply pressure PSP if the load sensing pressure LSP of the valve reaches a pre-defined upper limit.

Since the load sensing pressure LSP reported by a valve is indicative of the pressure at a working port of the valve, monitoring the load sensing pressure LSP and limiting the pump supply pressure PSP in dependence on load sensing pressure LSP enables the pump supply pressure to be raised without exceeding a maximum permitted pressure at the working port.

In an embodiment, the one or more controllers are configured to monitor pressure signals from some or all the pressure sensors in the E-LS system and to stop increasing the pump supply pressure PSP if a load sensing pressure LSP reported by any of the monitored pressure signals reaches a respective pre-defined upper limit.

By monitoring the load sensing pressure LSP all or some of the valves, the system can ensure that none of the monitored valves exceeds a permitted maximum pressure at a working port. This enables the pump supply pressure PSP to be raised to meet a hydraulic demand safely without imposing a default maximum limit on the pump supply pressure PSP which might otherwise restrict the ability of the system to meet a hydraulic demand dynamically.

In an embodiment, the one or more controllers are configured to apply different pre-defined upper limits of load sensing pressure LSP in respect of at least two of the valves and/or pressure sensors.

In an embodiment, the one or more controllers are configured to compare the load sensing pressure LSP reported by each of the monitored pressure signals with a respective pre-defined upper limit, in which the respective pre-defined upper limit is a value assigned to the pressure sensor forwarding the pressure signal and/or to a valve associated with that pressure sensor.

In an embodiment, at least one pressure sensor is associated with two or more valves, the arrangement configured such the highest load sensing pressure LSP generated by any of the associated valves at any given time is forwarded to the pressure sensor. The one or more controllers are configured to stop increasing the pump supply pressure PSP if the load sensing pressure LSP reported by a pressure signal from the pressure sensor reaches a respective pre-defined upper limit, irrespective of which of the associated valves is generating the load sensing pressure LSP reported by that pressure sensor.

In an embodiment, at least one pressure sensor is associated with two or more valves, the arrangement configured such the highest load sensing pressure LSP generated by any of the various associated valves at any given time is forwarded to the pressure sensor. The one or more controllers are configured to assign a different respective pre-defined upper limit of load sensing pressure LSP to at least two of the associated valves. The one or more controllers are configured to determine which of the associated valves are activated when a pressure signal from that pressure sensor is indicative that a load sensing pressure LSP is being generated by at least one of the associated valves and to stop increasing the pump supply pressure PSP if the load sensing pressure LSP reported by the pressure signal reaches a lowermost one of the pre-defined upper limits assigned to the associated valves that are determined to be actuated at the time. In an embodiment, each of the associated valves has a valve controller and/or is operatively connected with a user interface, the one or more controllers configured to interrogate data from the user interfaces and/or valve controllers of the associated valves in order to determine which of the associated valves is being actuated.

In an embodiment, the one or more controllers are configured to limit the pump supply pressure PSP to a default maximum pump supply pressure PSP when not operating in the at least one mode of operation. In an embodiment, the one or more controllers are configured when operating in the at least one mode of operation to increase the pump supply pressure PSP above the default maximum pump supply pressure PSP if required to meet a hydraulic demand of a consumer, but to limit the pump supply pressure PSP such that none of the load sensing pressures LSP reported by the pressure sensors exceeds a respective pre-defined upper limit.

In some embodiments, there is provided a mobile machine having a hydraulic supply system including a pump supply for supplying a pressurized fluid to a plurality of consumers on the mobile machine and/or an implement attached to the mobile machine and a control system for controlling the hydraulic supply system set out above.

The mobile machine may be an agricultural vehicle and may be an agricultural tractor.

In some embodiments, there is provided a method of controlling a hydraulic supply system on a mobile machine, wherein the hydraulic supply system includes a pump supply for supplying a pressurized fluid to a plurality of consumers on the mobile machine and/or an implement attached to the mobile machine. The control system includes an electronic load sensing (E-LS) system for controlling a pump supply pressure PSP of the pump supply in dependence on a hydraulic load demand of at least some of the consumers. The E-LS system includes one or more controllers and a plurality of pressure sensors, each pressure sensor associated with at least one valve of the hydraulic supply system and configured to forward to the one or more controllers a pressure signal indicative of a sensed load sensing pressure LSP of the at least one associated valve. The method comprises monitoring pressure signals from the pressure sensors and to increase the pump supply pressure PSP in response to an increase in the load sensing pressure LSP of one of the valves above the pump supply pressure PSP in an effort to raise the pump supply pressure PSP to match the load sensing pressure LSP. The method further comprises when operating in at least one mode of operation, stopping any further increase in pump supply pressure PSP if the load sensing pressure LSP of the valve reaches a pre-defined upper limit.

Because the load sensing pressure LSP reported by a valve is indicative of the pressure at a working port of the valve, monitoring the load sensing pressure LSP and limiting the pump supply pressure PSP in dependence on load sensing pressure LSP enables the pump supply pressure PSP to be raised without exceeding a maximum permitted pressure at the working port.

In an embodiment, the method comprises monitoring pressure signals from some or all the pressure sensors in the E-LS system and stopping any further increase in the pump supply pressure PSP if a load sensing pressure LSP reported by any of the monitored pressure signals reaches a respective pre-defined upper limit.

By monitoring the load sensing pressure LSP all or some of the valves, the system can ensure that none of the monitored valves exceeds a permitted maximum pressure at a working port. This enables the pump supply pressure PSP to be raised to meet a hydraulic demand safely without imposing a default maximum limit on the pump supply pressure PSP which might otherwise restrict the ability of the system to meet a hydraulic demand.

In an embodiment, the method comprises applying different pre-defined upper limits of load sensing pressure LSP in respect of at least two of the valves and/or pressure sensors.

In an embodiment, the method comprises comparing the load sensing pressure LSP reported by each of the monitored pressure signals with a respective pre-defined upper limit, in which the respective pre-defined upper limit is a value assigned to the pressure sensor forwarding the pressure signal and/or to a valve associated with that pressure sensor.

In an embodiment, at least one pressure sensor is associated with two or more valves, the arrangement configured such the highest load sensing pressure LSP generated by the associated valves at any given time is forwarded to the pressure sensor. The method comprises stopping further increase in the pump supply pressure PSP if the load sensing pressure LSP reported by a pressure signal from the pressure sensor reaches a respective pre-defined upper limit, irrespective of which of the associated valves is generating the load sensing pressure LSP reported by that pressure sensor.

In an embodiment, at least one pressure sensor is associated with two or more valves, the arrangement configured such the highest load sensing pressure LSP generated by the associated valves at any given time is forwarded to the pressure sensor. The method comprises assigning a respective pre-defined upper limit of load sensing pressure LSP to at least two of the associated valves, determining which of the associated valves is/are being activated when a pressure signal from that pressure sensor is indicative that a load sensing pressure LSP is being generated by at least one of the associated valves, and stopping any further increase in the pump supply pressure PSP if the load sensing pressure LSP reported by the pressure signal reaches a lowermost one of the pre-defined upper limits assigned to those of the associated valves that are determined to be actuated at the time. In an embodiment, each of the associated valves has a valve controller and/or is operatively connected with a user interface. The method comprises interrogating data from the user interfaces and/or the valve controllers in order to determine which of the associated valves is being actuated.

In an embodiment, the method comprises limiting the pump supply pressure PSP to a default maximum pump supply pressure PSP when not operating in the at least one mode of operation. In an embodiment, the method comprises when operating in the at least one mode of operation, allowing the pump supply pressure PSP to be increased above the default maximum pump supply pressure PSP if required to meet a hydraulic demand of a consumer but limiting the increase in pump supply pressure PSP to an amount which does not increase the load sensing pressure LSP reported by any of the pressure sensors above a respective pre-defined upper limit.

The method may be applied to the control systems described above.

In a further embodiment, there is provided computer software comprising computer readable instructions which, when executed by one or more processors, causes performance of the methods described above.

A further embodiment provides a computer readable storage medium comprising the computer software. Optionally, the storage medium comprises a non-transitory computer readable storage medium.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Embodiments will now be described, by way of example only, with reference to the further accompanying drawings, in which:

FIG. 1 illustrates part of a simplified known CC-LS hydraulic circuit;

FIG. 2 illustrates part of a simplified OC-LS hydraulic circuit;

FIG. 3 illustrates how a pump supply including a variable displacement pump can be adapted to incorporate a solenoid-controlled pressure limiting valve for use with an E-LS system;

FIG. 4 is a schematic side view of an agricultural machine and implement combination;

FIG. 5 is a schematic representation of an embodiment of a hydraulic system embodied in the combination of FIG. 4.

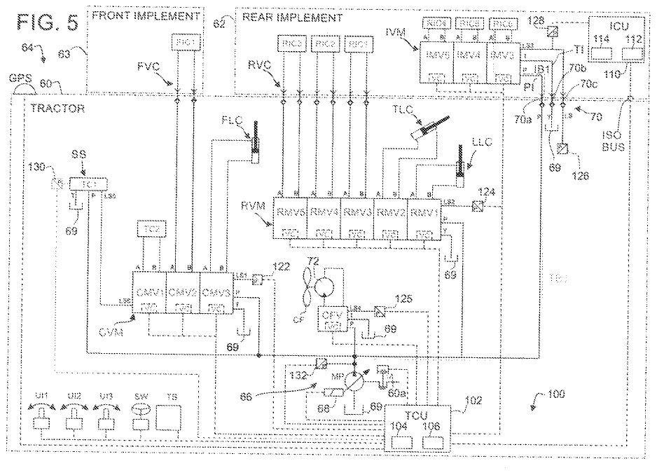

FIG. 4 illustrates a combination comprising a mobile agricultural machine 60 and an implement 62 attached to the rear of the machine. The implement 62 can be any suitable agricultural implement attachable to an agricultural machine having hydraulic consumers supplied with pressurized hydraulic fluid from a hydraulic supply system on the machine 60. The implement 62 will be referred to as a rear implement 62 and a further implement having hydraulic consumers fed by the supply on the machine, not shown in FIG. 4 but see FIG. 5, may be attached to the front of the tractor and will be referred to as a front implement 63.

The agricultural machine in the embodiment shown in the drawings and described below is specifically an agricultural tractor 60 and the rear implement 62 is a baler. Other types of rear implement commonly used with tractors include, without limitation, a loading wagon, a towed sprayer, and a towed potato harvester. Furthermore, the disclosure is not limited to application on tractors or other mobile agricultural machines but can be adapted for use with other mobile machines having a hydraulic supply system whether connected with an implement or not.

FIG. 5 is a simplified representation of a hydraulic supply system 64 suitable for use on the tractor 60 and implement 62, 63 combination. The hydraulic supply system 64 incorporates an E-LS system and is configured as disclosed herein.

### Hydraulic Network

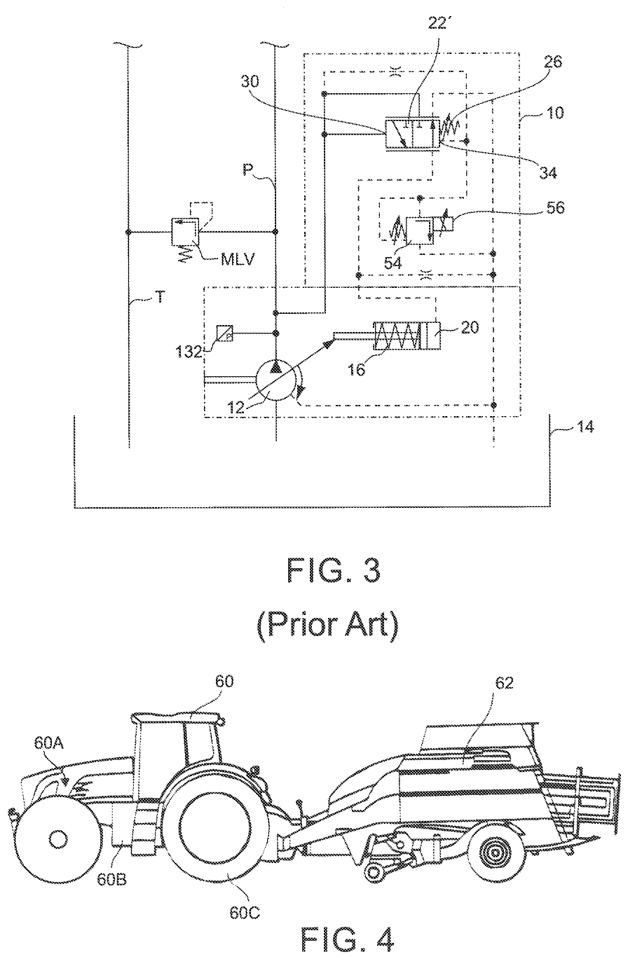

The hydraulic supply system 64 has pump supply 66 including main pump MP which is of variable displacement type and a pump output controller 68 for adjusting the displacement of the pump. In an embodiment, the pump output controller 68 is configured in a manner similar to that illustrated in FIG. 3. However, in other embodiments, alternative pump output controller arrangements can be adopted including any of those currently used with E-LS systems which enable an electronic controller to regulate and adjust the flow and/or pressure output of the pump supply 66.

The pump MP draws fluid from a tank 69 and supplies pressurized hydraulic fluid at a pump supply pressure PSP to consumers on the tractor and the implement via a pump supply line P. The tank 69 provides a reservoir for the hydraulic supply system in which the fluid is held generally at ambient pressure. The tank 69 is illustrated schematically in FIG. 5. In practice in any given hydraulic supply system 64 there may a single tank 69 or multiple tanks 69.

The consumers on the tractor 60 include a hydraulic steering system SS, a central valve manifold CVM, and a rear valve manifold RVM.

The steering system SS may include a hydraulic cylinder and control valve designated tractor consumer TC1 for moving the steered wheels. The control valve is connected to the pump supply line via a pressure port P and to the tank via a tank port T.

The central valve manifold CVM is installed generally in or towards the middle of the tractor and includes a number of functional valves for controlling a corresponding number of hydraulic consumers located usually in or towards the middle and front area of the tractor. In the example illustrated, the central valve manifold CVM includes three functional valves CMV1, CMV2, CMV3 assembled together and connected to the pump supply line via a common pressure port P and to a return line to the tank at a common return port T. Each valve is assigned to a specific consumer and the valves CMV1, CMV2, CMV3 may have different configurations (e.g., ON/OFF, proportional valves, 3/2 valves, 4/2 valves) according the functional needs of their respective consumer. The valves CMV1, CMV2, CMV3 are solenoid valves and each has a valve controller VC for controlling the solenoid. The number and configuration of the valves in the CVM may be varied to meet the requirements of the tractor manufacturer and/or the end customer. There may, for example, be more or fewer than three functional valves in the CVM.

The CVM has a common load sensing port LS1 and each of the valves CMV1, CMV2, CMV3 have LS ducts connected to the common LS port LS1 by means of shuttle valves so that the highest load sensing pressure LSP generated by the various valves CMV1, CMV2, CMV3 at any given point in time is forwarded to the LS port.

The CVM can be used to supply hydraulic fluid to various consumers such as, without limitation, a front linkage actuator FLC and an axle suspension system indicated as tractor consumer TC2. Valves in the CVM can also be used to supply consumers on a front implement 63 attached to the tractor indicated as FIC1. Each consumer on the front implement 63 being hydraulically connected to a respective valve CMV2 via front valve couplings FVC.

The RVM is installed in the rear of the tractor and is provided to supply consumers which are mainly in the rear area of the tractor and/or on a rear implement 62. The RVM is similar to the CVM in terms of design and variability and contains a number of functional valves indicated as RMV1 to RMV5 assembled together and connected to the pump supply line via a common pressure port P and to a return line to the tank at a common return port T. At least some of the valves in the RVM may be used to supply consumers on a rear implement 62 and/or on the tractor 60. In the exemplary embodiment illustrated, three of the valves, RMV3, RMV4, and RVM5, are connected with respective consumers RIC1, RIC2, RIC3 on the rear implement 62 via rear valve couplings RVC. The RVC may be directly flanged to the RVM as described in European Patent Application Publication 2886926 A1, “Hydraulic Coupling Seal,” published Jun. 24, 2015. As it is common to attach complex implements to the rear of a tractor, there may be more than three valves in the RVM for connection to consumers on a rear implement 62. There may, for example, be as many as six, seven, eight or more valves in the RVM assigned for connection to consumers on rear implements. At least some of the valves in the RVM may be assigned to consumers located at or towards the rear of the tractor such as actuators on a rear linkage system. In the exemplary embodiment shown, valve RMV1 is assigned to a pair of lower link hydraulic cylinders LLC being supplied in parallel and valve RMV2 is assigned to a hydraulically driven top link actuator cylinder TLC. In an alternative embodiment, the top link actuator may be a mechanical actuator and the valve RMV2 used for other purposes.

Each valve RMV1 to RMV5 in the RVM is a solenoid actuated valve and is provided with a valve controller VC which moves the solenoid and provides a pilot pressure. Each valve is configured according to the requirements of its respective consumer (e.g., ON/OFF, proportional valves, 3/2 valves, 4/2 valves).

The RVM has a common load sensing port LS2 and LS ducts of the valves RMV1, RMV2, RMV3, RMV4, RMV5 are all connected to the common LS port LS2 by means of shuttle valves so that the highest load sensing pressure LSP generated by the various valves at any given point in time is forwarded to the common LS port.

As with the CMV, the RVM can be configured to have any required number and configuration of valves depending on the number and requirements of the hydraulic consumers on the tractor and any implements that are expected to be attached to the tractor. It should be understood, therefore, that the configuration of the CVM and RVM shown in FIG. 5 is for illustrative purposes only and can be varied.

The hydraulic supply system 64 includes a power beyond interface 70 to provide an “uncontrolled” supply of pressurized fluid to a rear implement 62 which requires more hydraulic functions than can be controlled using the available valves on the tractor. Such a complex implement 62 may be a baler, for example. The power beyond interface 70 includes quick release couplings 70a, 70b to connect the pump supply line P and a return tank line T on the tractor to a pump pressure supply line PI and a return line TI respectively on the implement 62. The power beyond interface provides a pressurized fluid supply to an implement which is at the pump supply pressure PSP but which is otherwise uncontrolled on the tractor.

In a typical arrangement, the rear implement 62 has an implement valve manifold IVM similar to the CVM and RVM as described above. The IVM has a number of functional control valves IMV1 to IMV3 which are each connected to the implement pump supply pressure line PI through a common pressure port P and to the implement return line TI via a common return port T. The IVM also has a common LS pressure signal port LS3 to which LS ducts of each of the valves IMV1 to IMV3 are connected via a series of shuttle valves or the like arranged so that the highest consumer load sensing pressure LSP from the various valves in the IVM at any given point in time is reported to the common LS port LS3. Each valve IMV1 to IMV3 is connected to a respective consumer (e.g. a hydraulic cylinder or hydraulic motor) which are schematically designated RIC4 to RIC6. Each valve is configured according to the requirements of its respective consumer (e.g., ON/OFF, proportional valves, 3/2 valves, 4/2 valves). The valves are all solenoid-controlled valves and each is provided with an electronic valve controller VC which moves the solenoid and provides a pilot pressure (supplied via pump connection to support the valve slider movement).

The number of valves in the IVM is selected depending on the number of consumers on the implement that are to be supplied via the power beyond interface and can be varied as required. Furthermore, there may be more than one valve manifold on the implement and/or one or more separate valves not incorporated into a manifold can be connected to the power beyond interface via suitable hydraulic lines.

In the embodiment shown, the tractor has a further hydraulic consumer in the form of a hydraulic motor 72 for driving a cooling fan CF. The hydraulic motor 72 is controlled by a cooling fan valve CFV which regulates the cooling fan motor to vary the speed of the fan. The CFV is a solenoid-controlled valve having an electronic valve controller VC which is operably connected with an electronic controller 102 on the tractor. The controller is configured to actuate the CFV in order to adapt the motor speed to the cooling demand.

As illustrated in FIG. 3, the hydraulic supply system may also be provided with a main pressure limiting valve MLV which opens to vent the pump supply P to the tank 69 if the pressure exceeds a predetermined pressure. The MLV is set to open at a pressure above the maximum permitted operating pressure of the system. This provides an additional level of safety in case the limitation of the pump supply pressure PSP through the pump controller should fail. For use with current tractor hydraulic supply systems, the MLV may be set to open a pressure value of around 250 bar, for example. However, the pressure at which the MLV opens can be selected as appropriate for any given system.

The hydraulic supply system 64 illustrated in FIG. 5 is exemplary only and can be modified for use with hydraulic supply systems which have alternative layouts, including an alternative number and type of consumers and control valves. For example, the tractor 60 may have more than one pump and may have a fixed displacement pump in addition to the main pump MP for supplying other consumers such as a lubrication system for the driveline, a transmission (of hydrostatic-mechanical split type) or a hydraulic brake system, for example. These are not shown in FIG. 5 as they are not included in the E-LS control arrangements which are the subject of the present disclosure.

### Electronic Network

FIG. 5 also illustrates an electronic control system network 100 for the hydraulic supply system 64. As shown, the control network 100 includes a controller 102 on the tractor having an electronic processor 104. The processor 104 is operable to access a memory 106, which may be part of the controller 102, and execute instructions stored therein to perform the steps and functionality disclosed. The memory 106 may include any one or a combination of volatile memory elements (e.g., random-access memory RAM, such as DRAM, and SRAM, etc.) and non-volatile memory elements (e.g., ROM, hard drive, tape, CDROM, etc.). The memory 106 may store a native operating system, one or more native applications, emulation systems, or emulated applications for any of a variety of operating systems and/or emulated hardware platforms, emulated operating systems, etc. The memory 106 may furthermore store parameters or settings needed to operate the control systems and/or perform the methods as described below.

It should be appreciated by one having ordinary skill in the art that in some embodiments, additional or fewer software modules (e.g., combined functionality) may be stored in the memory 106 or in additional memory. In some embodiments, a separate storage device may be coupled to the data bus, such as a persistent memory (e.g., optical, magnetic, and/or semiconductor memory and associated drives). In a further embodiment, the memory 106 may be connectable with an off-board network architecture (via mobile communication or WLAN) to provide parameters or settings.

The processor 104 may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the controller 102.

Electronic communications among the various components of the control network 100, as indicated by the dashed lines, may be achieved over a controller area network (CAN) bus or via a communications medium using other standard or proprietary communication protocols (e.g., RS 232, Ethernet, etc.). Communication may be achieved over a wired medium, wireless medium, or a combination of wired and wireless media.

The controller 102 is in communication with each of the electronic solenoid valve controllers VC of the various valves on the tractor, with the pump output controller 68, and with various user interfaces such as a steering wheel SW, valve rockers represented as UI1 and UI2, a linkage control represented as UI3, and a touch screen TS. The touch screen is typically located within a cab of the tractor to provide information to the driver and receive input (e.g. to select, adjust and/or save settings). The touch screen TS may alternatively be replaced or enhanced by a keyboard to receive input. Indeed, any input or presentation of information whether by manual, speech or gestures may be included herein. Each user interface UI may be permanently assigned to one consumer of the tractor or the implement. Alternatively, one or more of the user interfaces may be variably assignable to any one of two or more consumers by the operator. Such an assignment might be effected via the touch screen, for example.

The controller 102 may also receive further data, such as from a GPS receiver to determine the current position of the tractor, and/or may be operative to control further devices.

The rear implement 62 may also be connected to the tractor controller 102, say via a standardized agricultural ISOBUS for example, to exchange data and control between the implement and tractor as described below. For this purpose, the implement 62 may be provided with an implement controller 110 which communicates with the tractor controller 102. If present, an implement controller 110 may have an electronic processor 114 which is operable to access a memory 112 and execute instructions stored therein to perform the steps and functionality disclosed herein.

The memory 112 may include any one or a combination of volatile memory elements (e.g., random-access memory RAM, such as DRAM, and SRAM, etc.) and non-volatile memory elements (e.g., ROM, hard drive, tape, CDROM, etc.). The memory 112 may store a native operating system, one or more native applications, emulation systems, or emulated applications for any of a variety of operating systems and/or emulated hardware platforms, emulated operating systems, etc. The memory 112 may furthermore store parameters or settings needed to operate the control systems as described below.

It should be appreciated by one having ordinary skill in the art that in some embodiments, additional or fewer software modules (e.g., combined functionality) may be stored in the memory 112 or additional memory. In some embodiments, a separate storage device may be coupled to the data bus, such as a persistent memory (e.g., optical, magnetic, and/or semiconductor memory and associated drives). In a further embodiment, the memory 112 may be connectable with an off-board network architecture (via mobile communication or WLAN) to provide parameters or settings.

The processor 114 may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the controller 102.

### Load Sensing

Returning to the hydraulic supply system, at any given time, a highest of the load sensing pressure demands LSP from the consumers on the tractor 60 and any attached implements 62 is used to regulate the pump output controller 68 by means of a load sensing LS system. The load sensing system includes an electronic (electrohydraulic) load sensing (E-LS) system including a number of pressure sensors for sensing load sensing pressure demand signals LSP from consumers which are part of the E-LS system. Each of the pressure sensors is in communication with a controller 102 or 110 and forwards to the controller an electronic load sensing pressure signal ELSPS (a pressure signal) representative of the sensed consumer load sensing pressure LSP.

The electronic load sensing pressure signal ELSPS may be an analogue signal in which a characteristic of the signal is modulated in dependence on the pressure of the hydraulic load sensing pressure signal LSP. In an embodiment, the current of the ELSPS is modulated in dependence on the pressure of the hydraulic load sensing pressure signal LSP but in another embodiment it is the voltage. In an embodiment in which the ELSPS is an analogue signal, the controller 102, 110 converts the ELSPS into a pressure value by reference to data stored in the controller (or to which the controller has access) which provides a correlation between the modulated characteristic and pressure for the sensed load sensing pressure LSP. This data may be provided in the form of a characteristic map or a look up table assigned to the sensor. In another embodiment, the pressure sensor has a CPU and communicates with the controller through a CAN interface. In this case, conversion of the analogue signal to a pressure value is made at the sensor and the pressure value forwarded to the controller 102, 110.

In the embodiment illustrated, a first pressure sensor 122 is connected with the LS port LS1 on the CVM, where it is subject to the highest consumer load sensing pressure signal LSP of the valves in the CVM. A second pressure sensor 124 is connected with an LS port LS2 on the RVM, where it is subject to the highest consumer load sensing pressure signal LSP of the valves in the RVM. A third pressure sensor 125 is connected with an LS port LS4 on the cooling fan valve CFV to sense the load sensing pressure of the cooling fan motor.

A fourth pressure sensor 126 on the tractor is connected with a LS coupling 70c of the power beyond interface. On the implement, the LS power beyond coupling may be hydraulically connected with the common LS port LS3 of the IVM so that the highest load sensing pressure demand LSP from the various valves in the IVM is forwarded to the fourth pressure sensor 126 when the implement is coupled to the tractor. However, for implements which have a controller 112, an implement pressure sensor 128 can be connected with the common LS port LS3 of the IVM. In this case, the implement pressure sensor 128 communicates with the implement controller 112 and forwards to the implement controller 112 an electronic load sensing pressure signal ELSPS representative of the sensed consumer load sensing pressure LSP at the IVM common LS port LS3. The implement controller 112 forwards data relating to the sensed load demand pressure LSP to the tractor controller 102. The implement controller 110 may process the load sensing pressure demand data and forward to the tractor controller 102 data which is modified or a signal which is a function of the sensed load sensing pressure signal LSP.

The load sensing pressure demand LSP of the steering system is also sensed electronically to form part of the E-LS system. FIG. 5 illustrates two alternative arrangements. In one embodiment, an LS port LS5 of the steering system actuator/control valve TC1 is hydraulically connected by a LS signal line to an LS input port LS6 on the CVM. The LS input port LS6 is connected with the LS ducts of each of the valves in the CVM to the common LS port LS1 by a suitable cascade of shuttle valves so that the highest load sensing pressure demand LSP from the steering system and the various valves CMV1 To CMV3 is reported to the common LS port LS1 to be sensed by the first pressure sensor 122. In an alternative embodiment, a dedicated pressure sensor 130 is provided to sense the load demand pressure LSP of the steering system. The steering system pressure sensor 130 may be hydraulically connected to the LS port of the steering system and electronically connected to the tractor controller 102 to forward to the controller an electronic load sensing pressure signal ELSPS representative of a sensed consumer load sensing pressure LSP of the steering system.

The tractor controller 102 is configured to select an electronic load sensing pressure signal ELSPS representative of the highest consumer load sensing pressure LSP forwarded to it, either directly from a pressure sensor or from the implement controller 112. The controller processes the selected signal and forwards an electronic pump supply control signal EPSCS to the output controller 68 of the main pump MP to vary the output of the pump MP in dependence on the highest sensed load sensing pressure LSP. If the pump output controller 68 comprises a solenoid-controlled pressure limiting valve 54 as illustrated in FIG. 3, the tractor controller 102 forwards an electronic pump supply control signal EPSCS to actuate the solenoid of the pressure limiting valve 54 in order to vary the output of the main pump. Typically, the current of the electronic pump supply control signal EPSCS will determine the extent of movement of the solenoid and so will determine the pressure Pₛₑₜ of the resulting hydraulic pump supply control signal HPSCS applied to the LS port 34 of the flow control valve 22′ and hence the supply pressure PSP of the main pump. The resulting pump supply pressure PSP can be calculated by equation 1:

$$PSP = Δ {P}_{s t} + {P}_{s e t} \qquad Equation 1$$

where ΔPₛₜ is the static or stand-by pressure differential defined by the spring 26 in the flow control valve 22′, and Pₛₑₜ is the pressure of the hydraulic pump supply control signal HPSCS provided at the LS pressure port of the flow control valve.

If the implement has an electronical controller 110, communication between the tractor controller 102 and electronic components of the LS pressure control system on the implement, such as valve controllers VC and pressure sensors 128 of the IVM, is typically made via the implement controller 110, with data and instructions being transmitted between the implement controller 110 and the tractor controller 102 via a standardized ISOBUS connection.

In an embodiment, the controller 102 converts a target pressure value for Pₛₑₜ to a current value for forwarding to the solenoid-controlled pressure limiting valve 54 (or other transducer) as an analogue electronic pump supply control signal EPSCS. In another embodiment, the pump output controller 68 has a CPU and communicates with the controller 102 through a CAN interface. In this case, the controller 102 forwards the target set point pressure value Pₛₑₜ to pump controller 66 in an electronic pump supply control signal EPSCS through a CAN interface and the pump CPU converts the pressure value to an analogue signal for controlling the pressure limiting valve 54 or other transducer.

Conversion of the target pressure value for Pₛₑₜ to a current value may be made by reference to data which provides a correlation between a current value and the resulting pressure Pₛₑₜ generated by the solenoid-controlled pressure limiting valve 54 or other transducer. This data may be stored in, or is otherwise accessible to, the controller 102 or pump controller CPU and may be provided in a characteristic map or a look up table assigned to the valve 54 and/or the pump MP for example. In other embodiments it may be a voltage of the analogue which is modulated to control the output of the solenoid-controlled pressure limiting valve 54.

The pressure sensors, the one or more controllers 102, 110, and the pump output controller 68 can all be considered as part of a control system for the hydraulic supply system.

### Increase of the Maximum Hydraulic Performance/Pump Pressure Based on LS Pressure Signals

The standard ISO 10448 “Agricultural tractors—Hydraulic pressure for implements” limits the pressure at which hydraulic fluid is to be supplied to agricultural implements via the standardized interface couplings to a maximum pressure of 205 bar. This is to ensure safe operation and avoid damage caused by excessive pressures. An advantage of a standardized limit on the maximum pressure is that implements and their hydraulic components can be specified to this pressure limit. However, tractor manufacturers often use standard hydraulic pumps which may be specified for higher pressure levels, which may be in the region of about 250 bar for example. If a pump with a higher maximum pressure rating is used on a tractor it is necessary to limit the maximum operating pressure of the hydraulic supply system to comply with ISO 10448. Usually, the maximum operating pressure of the hydraulic supply system is the same as the maximum pump supply pressure PSP. The pump supply pressure PSP in conventional LS systems is commonly limited to a maximum of 200 bar.

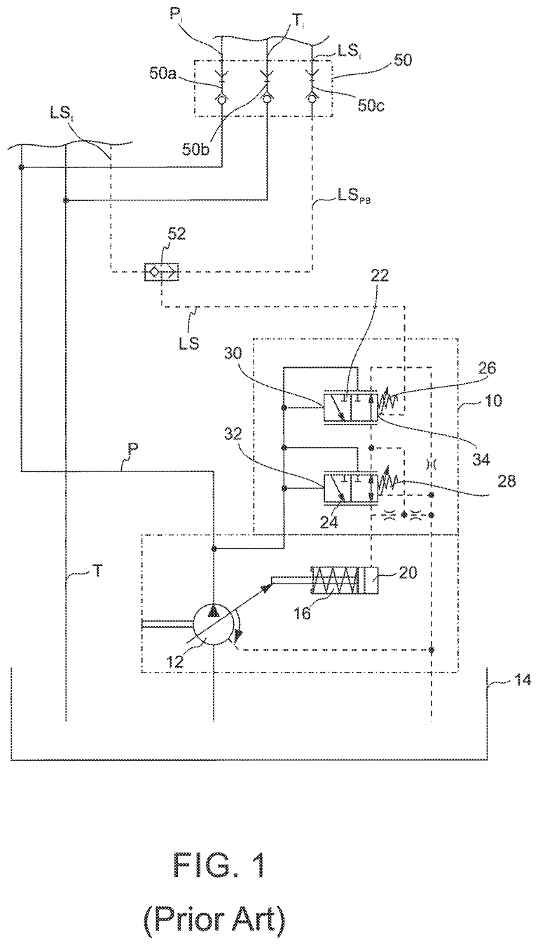

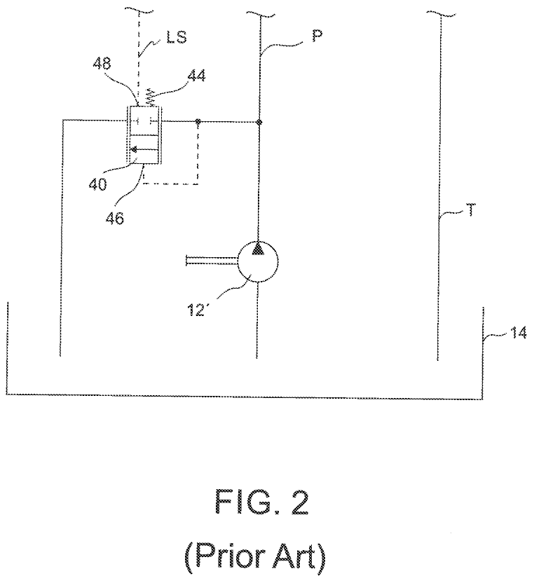

Various arrangements for limiting the maximum operating pressure of the hydraulic supply system are known. In a system having a CC-LS hydraulic circuit, such as that shown in FIG. 1, the pump supply pressure PSP is limited by the spring 28 of the pressure limiting valve 24. In a hydraulic system having E-LS as depicted in FIG. 3, the maximum pump supply pressure PSP can be regulated electronically using the pressure limiting valve 54 operating under the control of controller 102. Accordingly, if a hydraulic consumer forwards a high load sensing pressure LSP in excess of the maximum permitted operating pressure to the LS system the LS load sensing system will only increase the pump supply pressure PSP up to the maximum permitted operating pressure. As illustrated in FIG. 3, generally the hydraulic supply system of a tractor is also provided with a main pressure limiting valve MLV which opens to vent the pump supply P to the tank 69 if the pressure exceeds a predetermined pressure. This provides an additional level of safety in case the limitation of the pump supply pressure PSP through the pump controller should fail. In tractors, this is typically set above the maximum permitted operating pressure and the MLV in current tractor hydraulic systems are often set at a pressure value of around 250 bar.

Limiting the pump supply pressure PSP, for example to meet the requirements of ISO 10448, satisfies requirements for safety. However, there are situations in which this limitation results in insufficient supply of hydraulic fluid to a consumer.

Hydraulic valves commonly used on tractors require a minimum pressure differential Δpᵥ to be maintained across the valve in order to achieve a maximum delivery rate of the valve. This pressure differential Δpᵥ is typically set by a pressure compensator spring of the valve. For example, there are currently hydraulic valves on tractors that are capable of supplying implements with a delivery rate of up to 170 l/min (when the valve is at maximum throughput condition, fully opened) provided the control pressure difference Δpᵥ across the valve does not fall below a pressure of about 10 bar. The required pressure difference Δpᵥ for maximum delivery can vary for different valves and for valves specified at a lower delivery rate the required pressure difference Δpᵥ for maximum delivery may be lower.

In addition, throttling losses in the lines between the pump and the valve may cause a pressure loss or pressure drop Δp_{L} which additionally reduce the (maximum) pressure p_{V} which can be provided at the working port of a valve. For example, a pressure drop Δp_{L} in the region of 20 bar might be experienced at a flow level of 170 l/min depending on the length of the hydraulic lines between the pump and the valve.

The pressure Pᵥ at a working port of a valve at a given pump supply pressure PSP, taking into account the required control pressure differential Δpᵥ across the valve and the throttling losses Δp_{L}, can be calculated with the following equation:

$${p}_{v} = PSP - Δ {p}_{L} - Δ {p}_{v} \qquad Equation 2$$

Given the requirement to maintain a required pressure differential Δpᵥ across the valve and taking into account the pressure drop Δp_{L} due to throttling losses, a supply system may not being able to support the maximum possible delivery rate of a valve if the valve requires a pressure pᵥ at the working port which is at or close to the maximum operating pressure of the system to achieve the maximum flow rate. Taking as an example the valve RMV5. Assuming the pump supply pressure PSP is limited to a default maximum of 200 bar and that the maximum delivery rate of RMV5 is 170 l/min at a pressure pᵥ at a working port (e.g. port A of RMV5, FIG. 5) of 200 bar. If the valve requires a pressure drop across the valve Δpᵥ of 10 bar and assuming a pressure drop Δp_{L} of 20 bar due to throttling losses at the maximum flow rate 170 l/min, entering these values in equation 2 gives the maximum achievable pᵥ:

$${p}_{v ( RMV 5 )} = 200 bar - 20 bar - 10 bar = 170 bar \qquad Equation 2.1$$

As shown by equation 2.1 above, the maximum pressure pᵥ the system is capable of providing at the working port is 170 bar at the maximum delivery rate of 170 l/min. This is not sufficient to meet the 200 bar pressure required to support the maximum flow rate of the valve. Thus, even if the valve is reporting a load sensing pressure LSP which is not met at the default maximum PSP of 200 bar, the LS system is unable to increase the fluid delivery rate to satisfy the demand LSP. This results in low performance.

To overcome this problem, known systems enable the driver to adjust the maximum permitted pump supply pressure PSP, e.g. to raise the maximum system operating pressure limit above the default setting. In an E-LS system such as that depicted in FIG. 3, this can be easily achieved by enabling the driver to enter or select an increased limit for the pump supply pressure PSP in the control system for use by the controller 102. In a conventional hydraulic LS system, the setting of spring 28 may be adjustable. General this facility is provided in respect of internal consumers, e.g. consumers on the tractor such as for a front-end loader or the linkage system. The pressure capabilities of such internal consumers are well known to and controllable by the tractor manufacturer and so can be specified by the tractor manufacturer for a higher operating pressure than the default maximum system operating pressure, e.g. 200 bar. However, such systems may not conform to ISO 10448 as explained below with reference again to the above example of valve RMV5.

To achieve a delivery rate of 170 l/min at valve RMV5, the pump supply pressure PSP must be raised to 230 bar. This is sufficient to compensate for the throttling losses Δp_{L} of 20 bar and the required pressure differential Δpᵥ of 10 bar across the valve so that the pressure pᵥ provided at the working port of the valve is raised to 200 bar as illustrated below, in which the increased PSP of 230 bar is entered in equation 2:

$${p}_{v ( RMV 5 )} = 230 bar - 20 bar - 10 bar = 200 bar ( at 170 l / min ) \qquad Equation 2.2$$

Provided the pump is rated at 230 bar and the pressure pᵥ at the working port does not exceed 200 bar, both the pump and the valve RMV5 are operated at an acceptable pressure and the operation is in conformity with ISO 10448. However, if a further valve of the system is also supplied with hydraulic fluid at the increased maximum pump supply pressure PSP but which is subject to a lower pressure drop Δp_{L} due to throttling losses and/or a lower pressure drop Δpᵥ across the valve, the system may then not be safe and may not conform to ISO 10448. Taking as an example valve CMV2 which is associated with front implement consumer FIC1. Assuming valve CMV2 requires a similar pressure differential Δpᵥ of 10 bar but for which the losses Δp_{L} in the hydraulic lines are lower, say only 5 bar. If the valve CMV2 is supplied with fluid at the increased pump supply pressure PSP of 230 bar, the pressure pᵥ at a the working port of the valve would be raised to 215 bar as illustrated by entering the above values for CMV2 in equation 2:

$${p}_{v ( CMV 2 )} = 230 bar - 10 bar - 5 bar = 215 bar ( at 170 l / min ) \qquad Equation 2.3$$

As consequence, valve CMV2 would supply an attached implement FIC1 with hydraulic fluid at a pressure of 215 bar, which exceeds the maximum pressure level of 205 bar defined by ISO 10448. This results in uncompliant supply and may result in damage to the attached implement if the hydraulic system on the implement is not capable of handling a fluid pressure of 215 bar.

It is therefore a major drawback of the known systems that responsibility for setting for a limitation on the pump supply pressure PSP is given to a driver who cannot foresee the demand and/or losses of each valve/consumer present in the hydraulic system. Furthermore, though a manual intervention by the driver may be suitable for some consumers, it may be unsuitable for others. If the driver should forget to reset the pump supply pressure PSP limitation to the default value, this increased maximum pump supply pressure PSP remains in place even if hydraulic consumers are subsequently operated which require the lower default pump supply pressure PSP limitation.

In order to address the above issues, controller 102 is configured to monitor the load sensing pressures LSP reported by the pressure sensors as part of the E-LS system and to selectively adjust the pump supply pressure PSP above a default limitation value if required in order to meet a hydraulic demand of one or more of the consumers.

To ensure the pressure pᵥ at the working port of an actuated valve does not exceed a maximum permitted value for the valve and/or associated consumer, the controller 102 monitors the load sensing pressure LSP of the valve via the electronic load sensing pressure signal ELSPS from the associated pressure sensor. As the load sensing pressure LSP reported by a valve is an indication of the pressure pᵥ at the working port of a valve, the controller 102 is able to monitor the LSP of a valve to demine the pressure pᵥ at the working port. This provides a control loop which enables the controller to safely raise the pump supply pressure PSP while monitoring the associated LSP reported by the valve to ensure the pressure pᵥ at the working port does not exceed a pre-defined upper limit. For example, in relation to a valve, such as valve RMV5 or CMV2, which supplies consumers on an attached implement, the pre-defined upper limit may be set to comply ISO 10448 or any other regulatory limitation on the maximum pressure that can be supplied to an attached implement of the tractor.

Applying this to the previously discussed example in relation to valve RMV5, a pre-defined upper limit on the pressure at a working port of the valve p_{Vmax(RMV5)} is 200 bar to conform with ISO 10448. In order to deliver the maximum permitted pressure (at e.g. 170 l/min) at the working port the controller 102 generates and forwards the necessary control signal EPSCS to the pressure limiting valve 54 to raise the pump supply pressure PSP until the pre-defined upper limit p_{Vmax(RMV5)} of 200 bar is reached or the load sensing pressure signal LSP is balanced if this occurs earlier.

This method of control is advantageous as no further parameters such as the pressure difference across the valve Δpᵥ or a pressure loss or pressure drop Δp_{L} which are difficult to acquire need be known. Configuring the controller 102 to automatically control the maximum permitted pump supply pressure PSP removes many of the disadvantages of the known manual arrangements since the controller 102 can be configured to raise the pump supply pressure above the default maximum PSP_{max, default} only in respected of certain valves/consumers for which this is appropriate and can be configured to automatically revert to the default maximum PSP_{max, default}, e.g. once the hydraulic demand has been met.

Controlling the maximum pump supply pressure based on the load sensing pressure LSP reported from a single valve, such as RMV5 as discussed above, could result other consumers or valves in the system being supplied with fluid at a pressure that exceeds safe limits and/or which exceeds the limit set by ISO 10448. Referring to the above example, as discussed above with reference equation 2.3, raising the pump supply pressure to 230 bar to satisfy the hydraulic demands of RMV5 could result in the valve CMV2 being supplied with hydraulic fluid at a pressure of 215 bar at a working port, which would contravene ISO 10448 and may result in damage to an attached implement.

In some embodiments, the controller 102 is configured to compare load sensing pressure signals LSP from each of the LS pressure sensors 122, 124, 125, 126 and 130 in the hydraulic or electronic network to ensure that none exceed a pre-defined upper limit for the maximum pressure pᵥₘₐₓ at the working port of an associated valve. For example, in respect to valves which provide an external supply to attached implements, such as valves RMV3 to RMV5, CMV2 or IMV3 to IMV5, the pre-defined upper limit for pressure at a working port pᵥₘₐₓ may be set to 200 bar to comply with ISO 10448. However, the pre-defined upper limit pᵥₘₐₓ for any particular valve can be determined by any appropriate means, whether regulatory or otherwise. For example, for valves which supply internal consumers not falling under the restrictions of ISO 10448, the pre-defined upper limit for pressure pᵥₘₐₓ at the working port may be set higher 200 bar as appropriate to the pressure rating of the valve and/or associated consumer. The pre-defined upper limit for the pressure pᵥₘₐₓ at the working port of a valve may also be set lower than the limit provided under ISO 10448 if appropriate.

Since the pressure pᵥ at the working port of a valve is equal to the load sensing pressure LSP reported by the valve, monitoring the load sensing pressures signals LSP, as reported by the electronic load pressure signals ELSPS from the pressure sensors in the E-LS system, can be used to regulate the maximum pressure pᵥ at the working ports of all the valves monitored as part of the E-LS system. If a single pressure sensor is used to monitor the load sensing pressures LSP of multiple associated valves, the controller 102 may be configured to apply the lowest of the pre-defined upper limits pᵥₘₐₓ of all the associated valves when a load sensing pressure LSP is reported by that pressure sensor. Alternatively, the controller 102 may be configured to determine which of the valves associated with the pressure sensor are being actuated when a load sensing pressure LSP signal is reported and to apply the lowest of the pre-defined upper limits pᵥₘₐₓ of those associated valves that are being actuated. The controller 102 may be configured to interrogate data from user interfaces, e.g. IU1 to UI3, SW, assigned to the valves or data from the valve controllers VC to determine which valves are being actuated. For example, with reference to the rear valve manifold RVM, pre-defined upper limits for the pressure pᵥₘₐₓ at the working port may be set at 200 bar for valves RMV3 to RMV5 which supply the rear implement, and pre-defined upper limits for the pressure pᵥₘₐₓ at the working ports of valves RMV1 and RMV2 may be set higher, say at 220 bar, and may be in excess of the 205 bar limit under ISO 10448. Accordingly, when increasing the pump supply pressure PSP above the default limit PSP_{max, defalt}, the controller 102 will limit the PSP to prevent the load sensing pressure LSP reported by the pressure sensor 124 exceeding the 200 bar pre-defined upper limit if any of valves RMV3 to RMV5 are determined to be actuated but will permit the pump supply pressure to be increased until the load sensing pressure LSP reaches the higher pre-defined upper limit of 220 bar for valves RMV1 and/or RMV2 if none of valves RMV3 to RMV5 are determined to the actuated, provided of course that this does not cause the pre-defined upper limit for the pressure pᵥₘₐₓ at the working port of any other valves in the system be exceeded.

Regulating pump supply pressure PSP offers the major advantage, compared to known systems, that the maximum pump supply pressure PSP can be increased automatically by the controller 102 by considering the load demands of various consumers and losses present in the hydraulic network to enable the valves to be operated at or closer to their maximum capability while ensuring that the system is operated safely and is compliant with regulatory requirements.

Various modifications to the systems and methods will be apparent to those skilled in the art, without departing from the scope of the disclosure.

1. A control system for controlling a hydraulic supply system on a mobile machine, wherein the hydraulic supply system includes a pump supply for supplying a pressurized fluid to a plurality of consumers carried by the mobile machine, the control system comprising:
an electronic load sensing (E-LS) system for controlling a pump supply pressure (PSP) of the pump supply in dependence on a hydraulic load demand of at least some of the consumers, the E-LS system including at least one controller and a plurality of pressure sensors, each pressure sensor associated with at least one valve of the hydraulic supply system and configured to forward to the at least one controller a pressure signal indicative of a sensed load sensing pressure (LSP) of the at least one associated valve,
wherein the at least one controller is configured to monitor pressure signals from the pressure sensors and to increase the PSP in response to an increase in the sensed LSP of one of the valves associated with a pressure sensor above a current PSP;
wherein the at least one controller is configured when operating in at least one mode of operation compare the sensed LSP reported by each of the monitored pressure signals with a respective pre-defined upper limit, in which the respective pre-defined upper limit is a value assigned to at least one device selected from the group consisting of the pressure sensor forwarding the pressure signal and a valve associated with that pressure sensor, and to stop increasing the PSP if a sensed LSP reported by any of the monitored pressure signals reaches the respective pre-defined upper limit; and
wherein the at least one controller is configured to apply different pre-defined upper limits of LSP in respect of at least two of the at least one device selected from the group consisting of the pressure sensor forwarding the pressure signal and the valve associated with that pressure sensor.

2.-4. (canceled)

5. The control system of claim 1, wherein at least one of the pressure sensors is associated with at least two of the valves, wherein the at least one controller is configured to stop increasing the PSP if the sensed LSP reported by a pressure signal from the at least one of the pressure sensors reaches a respective pre-defined upper limit, irrespective of which of the associated valves is generating the LSP reported by the at least one of the pressure sensor.

6. The control system of claim 1, wherein at least one of the pressure sensors is associated with at least two of the valves, wherein the at least one controller is configured to assign a different respective pre-defined upper limit of sensed LSP to at least two of the associated valves, the at least one controller being configured to determine which of the associated valves are activated when a pressure signal from the at least one of the pressure sensors is indicative that a LSP is being generated by at least one of the associated valves and to stop increasing the PSP if the sensed LSP reported by the pressure signal from the at least one of the pressure sensors reaches a lowermost one of the pre-defined upper limits assigned to the associated valves that are determined to be actuated at the time.

7. The control system of claim 6, wherein each of the associated valves has a valve controller, the at least one controller configured to interrogate data from the valve controllers of the associated valves to determine which of the associated valves is being actuated.

8. The control system of claim 1, wherein the at least one controller is configured to limit the PSP to a default maximum PSP when not operating in the at least one mode of operation.

9. The control system of claim 8, wherein the at least one controller is configured when operating in the at least one mode of operation to increase the PSP above the default maximum PSP if required to meet a hydraulic demand of a consumer and to limit the PSP such that none of the sensed LSPs reported by the pressure sensors exceeds a respective pre-defined upper limit.

10. A mobile machine having a hydraulic supply system including a pump supply for supplying a pressurized fluid to a plurality of consumers carried by the mobile machine and the control system for controlling the hydraulic supply system of claim 1.

11. A method of controlling a hydraulic supply system on a mobile machine, wherein the hydraulic supply system includes a pump supply for supplying a pressurized fluid to a plurality of consumers carried by the mobile machine; the control system including an electronic load sensing (E-LS) system for controlling a pump supply pressure (PSP) of the pump supply in dependence on a hydraulic load demand of at least some of the consumers, the E-LS system including at least one controller and a plurality of pressure sensors, each pressure sensor associated with at least one valve of the hydraulic supply system and configured to forward to the at least one controller a pressure signal indicative of a sensed load sensing pressure (LSP) of the at least one associated valve, the method comprising:
monitoring pressure signals from the pressure sensors;
increasing the PSP in response to an increase in the sensed LSP of one of the valves above the PSP in an effort to raise the PSP to match the LSP; and
when operating in at least one mode of operation, stopping any further increase in the PSP a sensed LSP reported by any of the monitored pressure signals reaches a pre-defined upper limit, in which the respective pre-defined upper limit is a value assigned to at least one selected from the group consisting of the pressure sensor forwarding the pressure signal and a valve associated with that pressure sensor, and wherein the method comprises applying different pre-defined upper limits of LSP in respect of at least two of the at least one device selected from the group consisting of the pressure sensor forwarding the pressure signal and the valve associated with that pressure sensor.

12-14. (canceled)

15. The method of claim 11, wherein at least one of the pressure sensors is associated with at least two of the valves, the arrangement configured such the highest LSP generated by the associated valves at a time is forwarded to the at least one of the pressure sensors, the method comprising stopping further increase in the PSP if the sensed LSP reported by a pressure signal from the at least one of the pressure sensors reaches a respective pre-defined upper limit, irrespective of which of the associated valves is generating the sensed LSP reported by the at least one of the pressure sensors.

16. The method of claim 11, wherein at least one of the pressure sensors is associated with at least two of the valves, wherein the highest LSP generated by the associated valves at a time is forwarded to the at least one of the pressure sensors, the method comprising assigning a respective pre-defined upper limit of sensed LSP to at least two of the associated valves, determining which of the associated valves is/are being activated when a pressure signal from the at least one of the pressure sensors is indicative that a LSP is being generated by at least one of the associated valves and stopping any further increase in the PSP if the sensed LSP reported by the pressure signal from the at least one of the pressure sensors reaches a lowermost one of the pre-defined upper limits assigned to those of the associated valves that are determined to be actuated at the time.

17. The method of claim 16, wherein each of the associated valves has a valve controller, the method comprising interrogating data from the valve controllers to determine which of the associated valves is being actuated.

18. The method of claim 11, further comprising limiting the PSP to a default maximum PSP when not operating in the at least one mode of operation.

19. The method of claim 18, the further comprising:
when operating in the at least one mode of operation, allowing the PSP to be increased above the default maximum PSP if required to meet a hydraulic demand of a consumer and limiting the increase in PSP to an amount that does not increase the LSP reported by any of the pressure sensors above a respective pre-defined upper limit.

20. The mobile machine of claim 10, wherein the plurality of consumers comprises at least one selected from the group consisting of a consumer on the mobile agricultural machine and an implement attached to the mobile agricultural machine.

21. The control system of claim 7, wherein each valve controller comprises a user interface.

22. The control system of claim 6, wherein each of the associated valves is operatively connected with a user interface, the at least one controller configured to interrogate data from the user interface of the associated valves to determine which of the associated valves is being actuated.
